(19) United States
(12) Patent Application Publication
(10) Pub. No.: US 2003/0189186 A1
(43) Pub. Date: Oct. 9, 2003

(54) Chemical-mechanical polishing composition for metal layers

(75) Inventors: Yen Heng Chen, Panchiao City (TW); Yaun-Shin Li, Chung-Li City (TW)

Correspondence Address: BACON & THOMAS, PLLC, 625 SLATERS LANE, FOURTH FLOOR, ALEXANDRIA, VA, 22314

(73) Assignee: Everlight USA, Inc., Pineville, NC (US)

(21) Appl. No.: 10/108,438

(22) Filed: Mar. 29, 2002

(51) Int. Cl. C09K 13/00

(52) U.S. Cl. 252/79.1

(57) ABSTRACT

The present invention discloses a composition for chemical mechanical polishing of a metal layer at a high rate, which includes at least an oxidizing agent, a polishing promoter, an organic diproticic acid and deionized water. The polishing composition of the present invention can be applied alone or with an abrasive, and effectively improves the planarity of metal layers polished at high rates.

### BACKGROUND OF THE INVENTION

1. Field of the Invention

The present invention relates to a chemical-mechanical polishing (CMP) composition and more particularly, to a chemical-mechanical polishing composition for high-rate metal layer polishing, which is suitable for improving high-rate metal layer polishing planarity.

2. Description of the Related Prior Art

References regarding CMP composition can be easily found, for example, U.S. Pat. Nos. 5,340,370, 4,956,313, 5,137,544, 5,209,816, 5,980,775, 5,958,288, and 6,068,787, in which a conventional CMP composition primarily includes water, an abrasive, an oxidizing agent and an organic acid.

For conventional CMP compositions, increasing polishing rates is usually the major goal. However, CMP compositions frequently lead to metal surface defects and less planarity when applied, even though high-rate polishing can be achieved.

Therefore, it's desired to develop a CMP composition enabling high-rate polishing and good surface planarity.

### SUMMARY OF THE INVENTION

The object of the present invention is to provide a composition for high-rate metal layer chemical-mechanical polishing, which can improve planarity of varied metal layers after high-rate polishing; that is, the present invention provides a CMP composition enabling high-rate polishing and good metal surface planarity.

The composition of the present invention includes an oxidizing agent, a polishing promoter, an organic acid and deionized water, wherein the organic acid can be an organic diprotic acid. The preferred organic diprotic acid can be selected from a group consisting of oxalic acid, malonic acid, succinic acid, filmaric acid, and malic acid, or a mixture thereof.

The CMP composition of the present invention used to polish metal layers or thin films in semiconductor manufacturing can be applied alone or together with an abrasive or other chemicals. Accordingly, both high-rate polishing and good metal surface planarity can be achieved.

The term ‘high-rate polishing’ in this specification means the metal layer polishing rates are higher than 2000 Å/min. The term ‘high planarity’ means the planarity percentage is less than 8%. The planarity percentage is obtained by detecting 49 points uniformly distributed on a wafer surface with four CDE ResMap178 probes from Creative Design Engineering Inc. A lower planarity percentage indicates greater planarity.

### DETAILED DESCRIPTION OF THE INVENTION

The chemical-mechanical polishing composition of the present invention can be applied to control planarity of metal layers polished at a high rate of over 2000 Å/min in semiconductor manufacturing.

The composition of the present invention for high-rate metal layer chemical-mechanical polishing primarily includes an oxidizing agent, a polishing promoter, an organic acid and deionized water; wherein the organic acid is an organic diprotic acid.

In this composition, the organic diprotic acid can be selected from a group consisting of oxalic acid, malonic acid, succinic acid, fumaric acid, and malic acid, or a mixture thereof. The organic diprotic acid is preferably provided at a concentration between 0.0001M and 1.0M.

The polishing promoter can be salts of Ag, Al, Ca, Co, Cr, Cu, Fe, Mo, Mn, Nb, Ni, Os, Pd, Ru, Sn, Ti, V, etc., or a mixture thereof; wherein salts of Cu, Al, Fe, K, Ca, Ti or a mixture thereof are preferred, and preferably copper nitrate at a concentration between 100 ppb-100 ppm. In the chemical mechanical polishing composition of the present invention, the polishing promoter has a concentration within 100 ppb-100 ppm.

The oxidizing agent of the present invention can be inorganic or organic peroxide, wherein hydrogen peroxide is preferred because no metal component is contained therein and no hazardous by-product and no degradation product are generated. In the present invention, the oxidizing agent can oxidize target metals into metal oxides or ions; for example, the copper layer can be oxidized into cupric oxide. The metal salts in the composition dissolve into anions and metal ions that can accelerate the above reaction. Meanwhile, the organic diprotic acid has totally or partially dissolved into hydrogen ions and anions. The anions can react with the metal surface, and this reaction can reduce scratches on the metal surfaces induced by an abrasive and over corrosion of the metal in polishing. The amount of oxidizing agent in the composition is typically between 2-15 wt. % to satisfy the CMP common metal processing requirements. In the present invention, less then 10 wt. % of the oxidizing agent can achieve good results. Further, the oxidizing agent can be restricted to less then 2 wt. %. In other words, only 0.0001-2 wt. % of the oxidizing agent is needed.

The deionized water in the composition is not restricted, for example, 30-99 wt. %.

The composition of the present invention can be also used with abrasives which can be metal oxides, for example, Al₂O₃, CeO, GeO, SiO₂, TiO₂, ZrO₂ or a mixture thereof; wherein SiO₂ and Al₂O₃ are preferred; and preferably Al₂O₃. The abrasive is usually within 0-20 wt. %, and preferably 0-2.5 wt. %. In general, varied or mixed types, or modified oxide particles are applied, and different abrasives can lead to different removing rates, planarity and polish performance. Furthermore, surface charges for various particles are different and may change with additives or pH values. So abrasives and additives should be matched with each other such that uniform abrasive distribution, preservation, and slurry cleaning are not hindered. Uniform abrasive distribution is fundamental and very important for preparing the slurry.

CMP composition preparation must ensure the oxidizing agent does not settle, coagulate or degrade. Additives such as surfactants, polymer stabilizers or other active-surface distributors can be added therein. The surfactants can be anionic, cationic, nonionic, zwitterionic or a mixture thereof.

The CMP composition of the present invention can be prepared with conventional methods. For example, the abrasive, the polishing promoter, the organic diprotic acid, the deionized water and other chemicals can be mixed with conventional skill, and then hydrogen peroxide is added into the mixture before using.

The CMP composition of the present invention can be used in a single system containing an abrasive, acid, salt, water, and an oxidizing agent, or a dual system wherein the oxidizing agent and other unstable chemicals are separated from the other components of the system.

According to the present invention, a particular relationship exists between the oxidizing agent, the polishing promoter and the organic diprotic acid so as to obtain better planarity and polishing rates.

The composition of the present invention can be applied to integrated circuit manufacturing and reaches a polishing rate over 2000 Å/min and planarity below 8%.

The experimental results of the present invention indicate that when the polishing rates are greater than 4000 Å/min, in most cases the planarity can still be kept below 6%.

In the present invention, planarity is measured by detecting 49 points uniformly distributed on a wafer with four point probe RS mapping tool CDE ResMap178 of Creative Design Engineering Inc. The CMP composition of the present invention is particularly suitable for polishing metal layers or thin films composed of Cu, Al, W, Al-Cu, Al-Si, Ti, TiO₂ or mixtures thereof, wherein Cu and Cu alloy are preferred.

### DESCRIPTION OF THE PREFERRED EMBODIMENTS

Comparative Example 1

(a) Preparation of a Conventional CMP Composition

1.0 wt. % Al₂O₃, 1.0 wt. % hydrogen peroxide, 5.0 ppm cupric nitrate and deionized water are mixed well according to common skills. The components of this slurry are listed in Table I.

(b) Polishing Test

The conventional CMP composition of (a) is applied to a copper piece with 10,000 Å thickness. An IPEC/WESTECH 472 polisher with a Rodel IC 1400 pad is used. The conditions are: down force 5 psi, back pressure 2 psi, polishing disk rotating speed 42 rpm, carrier rotating speed 45 rpm, and polishing slurry flow rate 150 mL/min. The test results are listed in Table II, wherein the polishing rate of the copper layer is 1700 Å/min and the planarity is 8.8%.

Comparative Examples 2-6

The steps of Comparative Example 1 are repeated to obtain conventional CMP slurries with varied components as shown in Table I, and the test results are listed in Table II.

### Example 1

(a) CMP Slurry Preparation According to the Present Invention

1.0 wt. % Al₂O₃, 1.0 wt. % hydrogen peroxide, 20 ppm cupric nitrate, 0.1 M oxalic acid and deionized water are mixed well according to common skills. The components of this slurry are listed in Table I.

(b) Polishing Test

The CMP composition of (a) is applied to a copper piece with 10,000 Å thickness. A IPEC/WESTECH 472 polisher with a Rodel IC 1400 pad is used. The conditions are: down force 5 psi, back pressure 2 psi, polishing disk rotating speed 42 rpm, carrier rotating speed 45 rpm, and polishing slurry flow rate 150 mL/min. The test results are listed in Table II, wherein the polishing rate of the copper layer can reach to 6,055 Å/min and the achieved planarity is 4.8%.

### Examples 2-8

The steps of Example 1 are repeated to obtain CMP slurries of the present invention with varied components as shown in Table I, and the test results are listed in Table II.

TABLE I

| | Abrasive | Oxidizing | Promoter | |
|---|---|---|---|---|
| | Al₂O₃ | agent H₂O₂ | Cupric nitrate | Acid |
| Sample | (wt. %) | (wt. %) | (ppm) | (0.1 M) |
| Comparative | 1 | 1 | 5 | — |
| Example 1 | | | | |
| Comparative | 1 | 1 | 10 | — |
| Example 2 | | | | |
| Comparative | 1 | 1 | 20 | — |
| Example 3 | | | | |
| Comparative | 1 | 1 | 20 | Phosphoric |
| Example 4 | | | | acid |
| Comparative | 1 | 1 | 20 | Nitric acid |
| Example 5 | | | | |
| Comparative | 1 | 1 | 20 | Acetic acid |
| Example 6 | | | | |
| Example 1 | 1 | 1 | 20 | Oxalic acid |
| Example 2 | 1 | 1 | 20 | Malonic acid |
| Example 3 | 1 | 1 | 20 | Succinic acid |
| Example 4 | 1 | 1 | 20 | Fumaric acid |
| Example 5 | 1 | 1 | 20 | Malic acid |
| Example 6 | 0 | 1 | 20 | Oxalic acid |
| Example 7 | 0 | 1 | 20 | Malonic acid |
| Example 8 | 0 | 1 | 20 | Succinic acid |

TABLE II

| | Polishing rate | Planarity |
|---|---|---|
| Sample | (Å/min) | (%) |
| Comparative Example 1 | 1700 | 8.8 |
| Comparative Example 2 | 2566 | 14.3 |
| Comparative Example 3 | 6152 | 22.3 |
| Comparative Example 4 | 7333 | 15.1 |
| Comparative Example 5 | 5223 | 8.8 |
| Comparative Example 6 | 3866 | 8.2 |
| Example 1 | 6055 | 4.8 |
| Example 2 | 3122 | 4.5 |
| Example 3 | 4405 | 4.2 |
| Example 4 | 2511 | 5.1 |
| Example 5 | 4012 | 5.5 |
| Example 6 | 4532 | 5.9 |
| Example 7 | 3933 | 5.4 |
| Example 8 | 4823 | 6.8 |

The test results of Comparative Examples 1-3 in Table II indicate that cupric nitrate can effectively improve polishing rates with increased concentrations. Unfortunately, the planarity of the metal surface worsens when cupric nitrate is added.

On the other hand, the test results of Comparative Examples 4-6 in Table II indicate that when phosphoric acid, nitric acid or acetic acid is added to the conventional compositions, different polishing effects are observed. For example, in Comparative Example 4, phosphoric acid can dramatically increase the polishing rate, but the generated planarity is worse. As for Comparative Examples 5 and 6, nitric acid and acetic acid do not significantly enhance the planarity, and scores of 8.8% and 8.2% are obtained respectively, which are over the required 8% mark.

As shown in Table II, planarity can be effectively improved by adding the organic diprotic acid in accordance with the present invention.

The present invention also provides compositions that include the oxidizing agent, the polishing promoter in a regulated amount and the organic diprotic acid, such as malonic acid, succinic acid, oxalic acid, fumaric acid, malic acid, etc., to obtain excellent polishing rates of over 2000 Å/min and superior planarity below 8% as shown in Table II,

### Examples 1-5

Furthermore, the test results of Examples 6-8 show that the CMP composition of the present invention can obtain excellent polishing results when no abrasive is involved and the oxidizing agent is added at a very low concentration. In Examples 1,3,5 and 6 polishing rates can reach up to 4000 Å/min, and the planarities thereof are still lower than 6%.

Although the invention is illustrated and described herein, it is nevertheless not intended to be limited to the details shown, since various modifications may be made therein without departing from the spirit of the invention and within the scope and range of equivalents of the claims.

What is claimed is:

1. A composition for chemical mechanical polishing of a metal layer at a high rate suitable for controlling planarity of a metal layer polished at a rate over 2000 Å/min in integrated circuit manufacturing; said composition comprising an oxidizing agent, a polishing promoter, an organic acid and deionized water, wherein said organic acid is an organic diprotic acid.

2. The composition of claim 1, wherein said organic diprotic acid is selected from a group consisting of oxalic acid, malonic acid, succinic acid, fumaric acid, and malic acid, or a mixture thereof.

3. The composition of claim 1, wherein said organic diprotic acid has a concentration ranging between 0.0001M and 1.0M.

4. The composition of claim 2, wherein said organic diprotic acid has a concentration ranging between 0.0001M and 1.0M.

5. The composition of claim 1, wherein said oxidizing agent is hydrogen peroxide.

6. The composition of claim 5, wherein said hydrogen peroxide is within 0.0001-10 wt. % with respect to said composition.

7. The composition of claim 1, wherein said polishing promoter is a metal salt, and said metal salt is selected from a group consisting of salts of Cu, Al, Fe, K, Ca and Ti, or a mixture thereof.

8. The composition of claim 1, wherein said polishing promoter is cupric nitrate.

9. The composition of claim 8, wherein said cupric nitrate has a concentration between 100 ppb-100 ppm.

10. The composition of claim 1, which further comprises an abrasive, and said abrasive is selected from a group consisting of Al₂O₃, CeO, GeO, SiO₂, TiO₂ and ZrO₂, or a mixture thereof.

11. The composition of claim 10, wherein said abrasive is Al₂O₃ having a concentration between 0-2.5 wt. %.

12. The composition of claim 1, wherein said planarity is defined as a planarity percentage less than 8%.

13. A composition for chemical mechanical polishing of a metal layer at a high rate suitable for controlling planarity of a metal layer polished at a rate over 4000 Å/min to less than 6% planarity percentage in integrated circuit manufacturing; said composition comprising an oxidizing agent, a polishing promoter, an organic acid and deionized water, wherein said organic acid is an organic diprotic acid.

14. The composition of claim 13, wherein said organic diprotic acid is selected from a group consisting of oxalic acid, succinic acid, and malic acid, or a mixture thereof.

15. The composition of claim 13, wherein said organic diprotic acid has a concentration between 0.0001M and 1.0M.

16. The composition of claim 14, wherein said organic diprotic acid has a concentration between 0.0001M and 1.0M.

17. The composition of claim 13, wherein hydrogen peroxide ranges between 0.0001-2.0 wt. %, cupric nitrate ranges between 100 ppb-100 ppm, deionized water ranges between 30-99 wt. %, and said organic diprotic acid ranges between 0.0001M-1.0M.

18. The composition of claim 13, which further comprises an abrasive, where said abrasive is selected from a group consisting of Al₂O₃, CeO, GeO, SiO₂, TiO₂ and ZrO₂, or a mixture thereof.

19. The composition of claim 17, which further comprises an abrasive, where said abrasive is selected from a group consisting of Al₂O₃, CeO, GeO, SiO₂, TiO₂ and ZrO₂, or a mixture thereof.

20. The composition of claim 18, wherein said abrasive is Al₂O₃ having a concentration between 0-2.5 wt. %.

21. The composition of claim 19, wherein said abrasive is Al₂O₃ having a concentration between 0-2.5 wt. %.

22. The composition of claim 1, wherein said metal layer is a copper layer or a copper alloy layer.

23. The composition of claim 13, wherein said metal layer is a copper layer or a copper alloy layer.
